(19) United States
(12) Patent Application Publication
(10) Pub. No.: US 2005/0259532 A1
(43) Pub. Date: Nov. 24, 2005

(54) ALL-IN-ONE DISC JOCKEY MEDIA PLAYER WITH FIXED STORAGE DRIVE AND MIXER

(75) Inventors: Christopher Roman, Wrentham, MA (US); Brian Shim, Santa Monica, CA (US)

Correspondence Address: BARLOW, JOSEPHS & HOLMES, LTD., 101 DYER STREET, 5TH FLOOR, PROVIDENCE, RI, 02903, US

(73) Assignee: NUMARK INDUSTRIES, LLC., Cumberland, RI (US)

(21) Appl. No.: 10/908,415

(22) Filed: May 11, 2005

Related U.S. Application Data
(60) Provisional application No. 60/570,795, filed on May 13, 2004.

(51) Int. Cl. G11B 5/09

(52) U.S. Cl. 369/47.1; 369/47.16

(57) ABSTRACT

An all-in-one media player and mixer for a disc jockey has a fixed storage device capable for storing media thereon. The media player also has two interfaces having independent selectable settings and corresponding removable media devices attached thereto. Each interface is connected to the fixed storage device and generates its own signal by playing media from the fixed storage device or its corresponding removable media device. The media player also has a mixer the selectively mixes the signal of the interfaces into a mixed signal and communicates it through an output.

### CROSS-REFERENCE TO RELATED APPLICATION

This application claims priority to earlier filed U.S. Provisional Application Ser. No. 60/570,795, filed May 13, 2004, the contents of which are incorporated herein by reference.

### BACKGROUND OF THE INVENTION

1. Field of the Invention

The present invention relates generally to disc jockey equipment. In particular, the present invention relates to the control and playback of dual audio in a configuration suitable for use by disc jockeys (“DJs”).

2. Background of the Related Art

In the prior art, it is desirous for a DJ to seamlessly fade from a first audio stream to a second audio stream and then back again. This is accomplished by using two audio sources connected to a sound system using a mixer that includes a fader. When one sound source is playing an audio stream, the second audio can be cued up ready for play. When it is desired to play the second audio stream rather than the first audio stream (for example, when the first audio stream is coming to an end), the first audio stream is faded out while the second audio stream is faded in. Thus, it is highly desirable by DJs to be able to play two audio streams at the same time.

A typical DJ setup includes two turntables with a mixer/fader positioned therebetween. Each of the turntables is capable of playing a vinyl record. The turntables can be used to playback the record in a normal fashion or the vinyl record can be scratched. Another example of a DJ setup is two CD players connected to a sound system by a mixer/fader. In both examples, the source of the sound stream is respectively from the music players.

New music technology provides for the storage of music files on a hard disk and playback therefrom. However, these well known devices provide for the playback of only one audio stream. This is not acceptable for a DJ who requires the ability to playback and mix two audio streams. Thus, there is a need to be able to store, playback and mix digitally recorded and stored music in a device that is configured in a fashion for use by a DJ, namely, two playback devices with mixing and cross fading capabilities. However, it is impractical, both economically and from a user stand point, to have two separate devices that house the same digital music files.

In the prior art, it is known to use two devices as controllers for manipulating and playing back music files on a computer with a computer monitor. However, this requires a separate computer and computer monitor which is not only expensive but not in a configuration that DJs are used to. Also, hard disk based players are known that can play back multiple audio streams for use by DJs. However, they do not have the physical configuration of including two turntables (or audio players) with a mixer residing therebetween.

### SUMMARY OF THE INVENTION

The present invention provides for a new and unique hard disk music player system that is specifically geared for DJs. In a single unit, a hard drive is provided that stores all of the digital music of the DJ in one location without requiring separate media, such as compact discs and memory cards, for example. Outputs for interconnection to a sound system are also provided. The unit is capable of playing more than one audio stream simultaneously. Prior hard disk players can play more than one audio stream simultaneously but have separate outputs for each audio stream for mixing and fading using a standalone mixer/fader. In contrast, the present invention integrates a mixer/fader directly into the hard drive unit that stores all of the DJ's music files. Most importantly, two separate sets of DJ-style controls are provided directly in the unit with a cross-fader positioned therebetween.

Optimally configured, an all-in-one media player and mixer for a disc jockey of the present invention has a fixed storage device capable for storing media thereon. The media player of the present invention also has two interfaces having independent selectable settings and corresponding removable media devices attached thereto. Each interface is connected to the fixed storage device and generates its own signal by playing media from the fixed storage device or its corresponding removable media device. The media player of the present invention also has a mixer the selectively mixes the signal of the interfaces into a mixed signal and communicates it through an output.

Accordingly, an object of the present invention is the provision for a DJ media player system that includes a fixed storage drive for storing media files thereon.

Another object of the present invention is the provision for a DJ media player system that includes removable media storage device.

Yet, another object of the present invention is the provision for a DJ media player system that can play two media streams simultaneously.

Yet, another object of the present invention is the provision for a DJ media player system that includes a mixer.

### BRIEF DESCRIPTION OF THE DRAWINGS

These and other features, aspects, and advantages of the present invention will become better understood with reference to the following description, appended claims, and accompanying drawings where:

FIG. 1 is a perspective of the preferred embodiment of the media player of the present invention;

FIG. 2 is a rear elevational view of the preferred embodiment of the media player of the present invention;

FIG. 3 is a partial top view of the preferred embodiment of the controls of the media player of the present invention;

FIG. 4 is a partial top view of the preferred embodiment of the display of the media player of the present invention;

FIG. 5 is a partial top view of the preferred embodiment of the mixing controls of the media player of the present invention;

FIG. 6 is a flow chart of the preferred embodiment of the operation of the media player of the present invention; and

FIG. 7 is a flow chart of the operation of an alternative embodiment of the media player of the present invention.

### DESCRIPTION OF THE PREFERRED EMBODIMENT

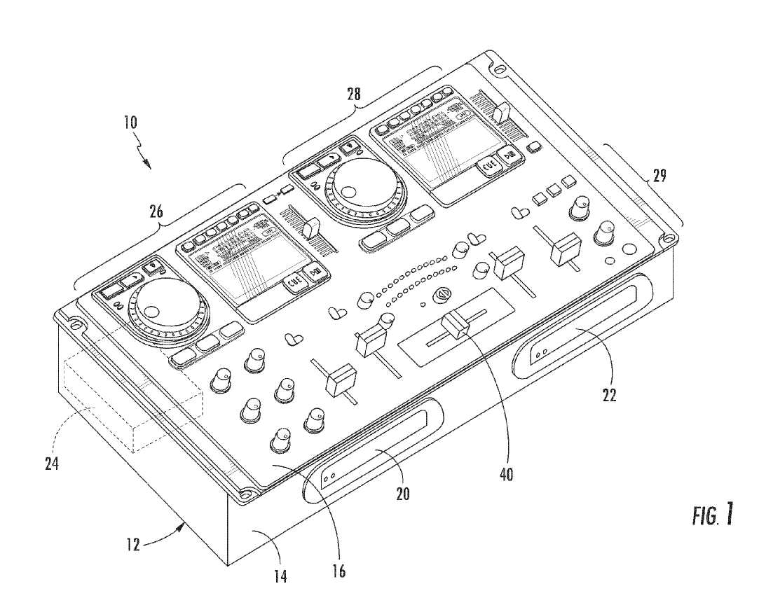

Referring to FIG. 1, the preferred embodiment of the media player of the present invention is shown generally at 10. The media player 10 has a unitary housing 12 with a front panel 14, a top panel 16 and a rear panel 18. The unitary housing 12 encloses a first removable media device 20 and a second removable media device 22 and a fixed storage device 24. The media player 10 also has two independent interfaces for selecting and cueing media to play from the removable media devices 20, 22, and/or fixed storage device 24. A mixer 29 is included to allow for seamless switching from one media being cueued and played from one interface to the other 26, 28.

Access to the second removable media devices 20, 22 is gained on the front panel 14 of the housing 12. The removable media devices 20, 22 are preferably CD optical drives, but could be other storage devices that utilize removable storage media, such as DVD optical drives, flash drives, or minidisks. Also enclosed in the housing 12 is a fixed storage device 24. The fixed storage device 24 is preferably a hard disc drive, but could be any other fixed storage medium that has fast data access speeds corresponding to low seek and latency characteristics. Although the media player 10 of the present invention will be described with reference to its ability to play audio, other media, such as video, could be utilized also.

The media player 10 of the present invention also includes two independent interfaces for selecting, playing and cueing music from the second removable media devices 20, 22 and/or the fixed storage device 24. Both interfaces 26, 28 have similar selectable settings, the primary difference being that the first interface 26 primarily controls the first removable media device 20 and the second interface 28 primarily controls the second removable media device 22. Both interfaces 26, 28 may access the fixed storage device 24. The controls of the interfaces 26, 28 will be more fully described below.

1. The Rear Panel

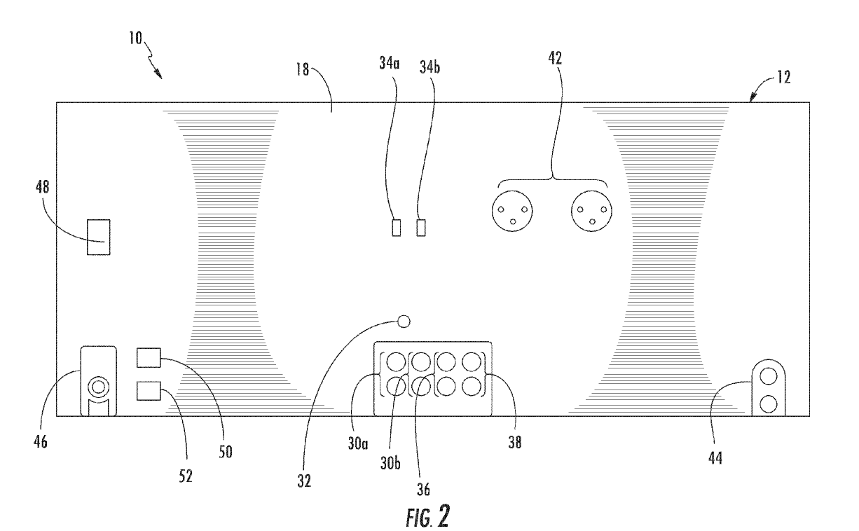

On the rear panel 18 of the housing 12 are a number of connectors as shown in FIG. 2. There are two sets of independent channel inputs 30a, 30b, each having a left and right channel, to input external audio sources into the media player 10. Such external audio sources could be other stand-alone turntables, HiFi VCRs, cassette and reel-to-reel tape decks, external hard drives, DAT machines, CD players, laser discs, tuners, synthesizers or even other mixing consoles. Also, included is a grounding lug 32 for an external turntable. Also included are level switches 34a, 34b to adjust the channel inputs 30 to receive line level input or phono level input depending on the type of equipment attached to the channel inputs 30a, 30b. When phono level input is selected, the audio source is fed directly to a high-quality RIAA phono pre-amplifier. Phono level input is only used for external turntables. Line level sources will overload the sensitive phono pre-amplifiers. Also included is a third line input 36 for connecting a device such as an external tape deck or external CD player. Also included are stereo main outputs 38. The stereo main outputs 38 are preferably unbalanced RCS connectors, but other connector types could be used. The critical aspect is that the audio ouput of the stereo main outputs 38 is unbalanced. The stereo main outputs 38 are controlled by the cross-fader control 40, which will be described in more detail below. Also included is a pair of balanced main outputs 42. The balanced main outputs 42 are preferably low-impedence XLR type connectors, but other types of connectors could be used. The critical aspect of the balanced main outputs 42 is that the output audio is balanced. The balanced main outputs 42 are also controlled by the cross-fader control 40. Also included is a microphone input 44 for connecting an external microphone thereto. Preferably, the microphone input 44 is a quarter inch plug that is a standard within the industry, but the type of jack is not critical to the invention and others could be used equally effectively. Also included are a power connector 46 and a power switch 48 for providing and controlling electrical power to the media player 10 of the present invention. Additionally, the media player 10 has, on the rear panel 18, a data port 50 for connecting the media player 10 to a personal computer and a keyboard connector 52 for the convenience of the DJ. These features will be described more fully below.

2. The Interface Controls

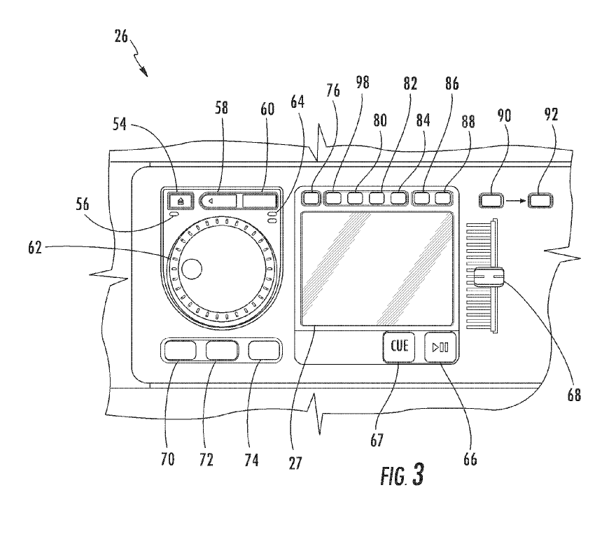

Referring now to FIG. 3, is a partial top view of the preferred embodiment of the controls of the media player 10 of the present invention is shown. The following discussion will describe the controls of the first interface 26, however, it is to be understood that this discussion is equally applicable to the second interface 28 and is merely explained only once as a matter of convenience. The first interface 26 has a display 27 and a number of controls to control the functions of the media player 10 and several indicators to inform the DJ of the various modes the media player 10.

The first interface 26 includes an open control 54. The open control 54 opens and closes the first removable media device 20. Just below the open control 54 is a disc-in indicator 56. The disc-in indicator 56 indicates whether a disc has been loaded into the first removable media device 20. Adjacent to the open control 54 is a back control 58. During music catalog browsing (described more fully below), the back control 58 is used to go back to previous menu level. The back control 58 is also used to go back to the previous track when the media player 10 is in play mode. Adjacent to the back control 58 is a select control 60. Activating the select control 60 puts the jog wheel 62 (described below) into select mode. During browsing, the select control 60 is used to move to the next menu level including selecting a track and auto-cueing. The select control 60 is also used to verify choices entered by the DJ, and advance to the next track when the media player 10 is in play mode. Below the select control 60 is a select indicator 64, which indicates when the select control 60 has been activated.

The first interface 26 also has a jog wheel 62, which is freely rotatable about an axis and has four behaviors depending on the mode it is in. During play in play mode, the jog wheel 62 is used to make momentary adjustments to the tempo of the music being played, called a “pitch bend.” Rotating the jog wheel 62 clockwise increases the tempo momentarily, and rotating it counter-clockwise will momentarily decrease the tempo. This feature allows the DJ to make minute adjustments to the tempo in order to synchronize the bass beats of two different songs together, a technique called “beat matching,” to facilitate a seamless performance. During pause in play mode, the jog wheel 62 is used to find a new cue point. When the jog wheel 62 is rotated while the music is paused, the music will sound. The DJ can find the precise point within the song that he or she wishes to start from. During search mode, the jog wheel 62 either fast forwards or rewinds. During select mode, the jog wheel 62 is used in combination with the select control 60 (described earlier) to navigate through the menus.

Below the display 27 is a play/pause control 66. Activating the play/pause control 66 a first time starts playback at the last set cue point. Activating the play/pause control 66 a second time pauses the playback and also puts the jog wheel 62 into pause-in-play mode. Activating the play/pause control 66 a third time restarts playback and sets a new cue point.

Adjacent to the play/pause control 66 is a cue control 67. Activating the cue control 67 while music is playing returns and pauses the music at the last set cue point. Activating and holding the cue control 67 a second time will play music from the cue point for as long as the cue control 67 is held. Activating the cue control 67 during select mode will bring the selected track into play mode and cues it to the beginning of the track.

Adjacent to the display 27 is a pitch control 68. The pitch control 68 allows the DJ to permanently adjust the tempo of the music to speed it up or slow it down. The pitch control 68 also has a neutral position to return the music to its original tempo. The DJ uses the pitch control 68 in conjunction with the jog wheel 62 in play mode facilitate beat matching of the songs in DJ's performance.

Below the jog wheel 62 are a set of loop controls including a loop-in control 70, a loop-out control 72 and a re-loop control 74. When activated, the loop-in control 70 sets a loop-in point for looping of music segments. By default, the loop-in point is also the initial cue point. Activating the loop-out control 72 sets a loop-out point. If the loop-out control 72 is activated during play will immediately return the playback to the loop-in point and proceed to play the music segment identified between the loop-in and loop-out points repeatedly until the loop-out control 72 is activated again. Activating the re-loop control 74 returns the playback of the music to the loop-in point and replays the music segment identified between the loop-in and loop-out points. The re-loop control 74 also has the function to perform a stutter.

Above the display 27 and reading from left to right, are a set of function controls including a search 76, info 78, time 80, mode 82, program 84, record 86, and save/del 88 controls. The search control 76 has two behaviors depending on the current mode the media player 10 is in. When the media player 10 is not in play mode, activating the search control 76 allows the DJ to use the jog wheel 62 to search and browse for music by artist, song, album and by playlist. When the media player 10 is in play mode, activating the search control 76 allows the DJ to use the jog wheel 62 to fast forward or rewind within the song.

The search control 76 automatically shuts off after eight (8) seconds of non-use in order to prevent inadvertent searching after the proper play point has been found. When the search control 76 is activated a search indicator 138 will indicate that the search control 76 is active. The search indicator 138 if located below the select control 60 and just above the select indicator 64.

Adjacent to the search control 76 is an info control 78. Activating the info control 78 indicates all the data relevant to the current track selected or being played. This will be more fully described below. If the info control 78 is activated and held for two (2) seconds the media player 10 will enter edit mode to allow the DJ to change the title of the track and edit various other features. This feature is more fully described below.

Adjacent to the info control 78 is a time control 80. The time control 80 toggles the time data that will be displayed between elapsed playing time, remaining time on the track, and remaining time on the album or play list.

Adjacent to the time control 80 is a mode control 82. The mode control 82 toggles between several play modes including: continuous play of the album or play list; single play of a single track; random continuous play of an album of play list; repeat play of an album or play list; and single repeat play of a single track.

Adjacent to the mode control 82 is a program control 84. The program control 84, when activated, allows the DJ to create play lists and sequence tracks within them.

Adjacent to the program control 84 is a record control 86. Activating the record control 86 will prompt the DJ to select either the first removable media device 20 or the inputs to record media. When media is within the first removable media device 20, the DJ will be presented with two options, either to rapid archive the contents of the CD or to save and compress the contents of the CD. These functions are more fully described below.

Adjacent to the record control 86 is a save/del control 88. The save/del control 88 is used to save edited information, play lists, and to execute commands to delete play lists and content.

Above the pitch control 68 is a relay control 90. When activated, the relay control 90 alternates play between the media sequenced in the first interface 26 and media sequenced in the second interface 28 as each sequence ends.

Adjacent to the relay control 90 is a utility control 92. The utility control 92, used in combination with the jog wheel 62, allows the DJ to activate following system functions: audio settings, password, enable auto door close, setting encoding bit rate, enabling CDDB look up, looking at the system capacity, checking the version number, delete songs, delete play lists, delete albums, defragmenting the storage drive, and formatting the storage drive. These functions are more fully described below.

3. The Displays

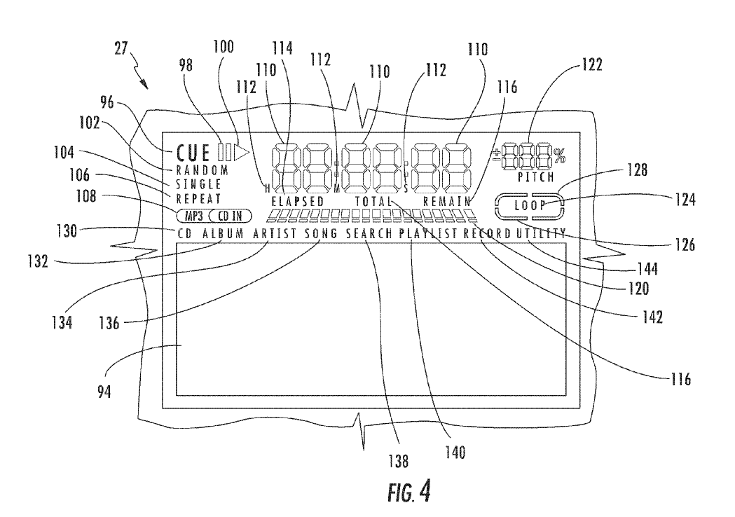

Referring now to FIG. 4, the display 27 of the interface of the preferred embodiment of the present invention is shown generally. Both displays 27 are identical to one another with the exception that the display 27 of the first interface 26 indicates the modes and settings set via the first interface 26 and the display 27 of the second interface 28 indicates the modes and settings set via the second interface 28. Therefore, it is to be understood that the following description of the display 27 is applicable to both the display 27 of the first interface 26 and the display 27 of the second interface 28 and that it is described only once as a matter of convenience.

The display 27 has a multitude of indicators informative of the different functions of the media player 10. In particular, the display 27 indicates whether media is playing or paused, whether cue points are set, elapsed or remaining time for track, album or play list, the loop mode set, the type of media loaded in the removable media drives, and other indicators of the various features of the media player 10. The display 27 also includes a matrix text area 94 for displaying play lists, menus, and other data pertinent to the settings and operation of the media player 10. The details of the indicators will be more fully described below.

In the upper left-hand corner of the display 27, is a cue indicator 96. The cue indicator 96 flashes when the DJ is setting a cue point. The cue indicator 96 lights continuously when the media player 10 is paused at a previously set cue point. Adjacent to the cue indicator 96 is a pause indicator 98. The pause indicator 98 indicates when the media player 10 has been paused by activating the play/pause control 66. Adjacent to the pause indicator 98 is a play indicator 100. The play indicator 100 indicates when the media player 10 is in play mode by activation of the play/pause control 66.

Beneath the cue 96, pause 98 and play 100 indicators, is a random indicator 102. The random indicator 102 indicates when the mode control 82 has been set to random play mode. Beneath the random indicator 102 is a single indicator 104. The single indicator 104 indicates when the mode control 82 has been set to single repeat play mode. Beneath the single indicator 104 is a repeat indicator 106. The repeat indicator 106 indicates when the mode control 82 has been set to repeat play mode. Beneath the repeat indicator 106 is media type indicator 108. The media type indicator 108 indicates the type of media that has been loaded into the media reader such as an MP3 formatted CD-Rom or an audio CD.

Adjacent to the play indicator 100 is a time display. The time display had a number of components including three pairs of digit indicators 110 to represent time that has elapsed or remaining depending on the setting of the time control 80. Adjacent to each pair of digit indicators 110 are time units indicators 112. The time units indicators 112 indicate the time units that the digit indicators 110 represent. The time unit indicators indicate whether the digit indicators 110 are hours, minutes and seconds, or whether the digit indicators 110 are indicating minutes, seconds and frames. Below the digit indicators 110 are three indicators: elapsed 114, total 116, and remaining 118. The elapsed indicator 114 indicates that the time displayed by the digit indicators 110 is the total time elapsed. The remaining indicator 116 indicates that the time displayed by the digit indicators 110 is the time remaining on a particular track. The total indicator 118 and remaining indicator 116, together, indicate that the time displayed by the digit indicators 110 is the total time remaining on the CD, album or play list (as appropriate).

Below the elapsed 114, total 116, and remaining 118 indicators is a time bar 120. The time bar 120 indicates graphically the time remaining, total time remaining or track elapsed time depending on the setting of the time control 80. Adjacent to the time display is a pitch indicator 122. The pitch indicator 122 indicates current pitch setting of the media player 10.

Below the pitch indicator 122 is a loop indicator 124. The loop indicator 124 indicates if playback is currently playing between loop points. Surrounding the loop indicator 124 is a loop ring indicator including a first segment 126 and a chase segment 128. The first segment 126 of the loop ring indicator indicates when media selected by loop points is playing. The chase segment 128 of the loop ring indicator indicates when a loop is playing.

Below the media type 108, time bar, and loop ring indicators are a number of source and mode indicators all in a row that indicate the source of playback and function modes of the media player 10. The source and mode indicators include a CD 130, album 132, artist 134, song 136, search 138, play list 140, record 142, and utility 144 indicators.

Starting from the left, the CD indicator 130 indicates if the source of the playback is from the corresponding removable media device. Adjacent to the CD indicator 130 is an album indicator 132. The album indicator 132 indicates when an entire album is being played from the album list (described below). Adjacent to the album indicator 132 is an artist indicator 134. The artist indicator 134 indicates when playback is from the artist list (described below). Adjacent to the artist indicator 134 is a song indicator 136. The song indicator 136 indicates when playback is from the song list (described below). Adjacent to the song indicator 136 is a search indicator 138. The search indicator 138 indicates when the media player 10 is in search mode. Adjacent to the search indicator 138 is a play list indicator 140. The play list indicator 140 indicates when playback is from a play list. Adjacent to the play list indicator 140 is a record indicator 142. The record indicator 142 indicates when the media player 10 is recording. Adjacent to the record indicator 142 is a utility indicator 144. The utility indicator 144 indicates when the utility control 92 has been activated.

Below the source indicators is a matrix text are. The matrix text area 94 displays a number of items such as track titles, programming text, and other media player 10 information.

4. The Mixing Controls

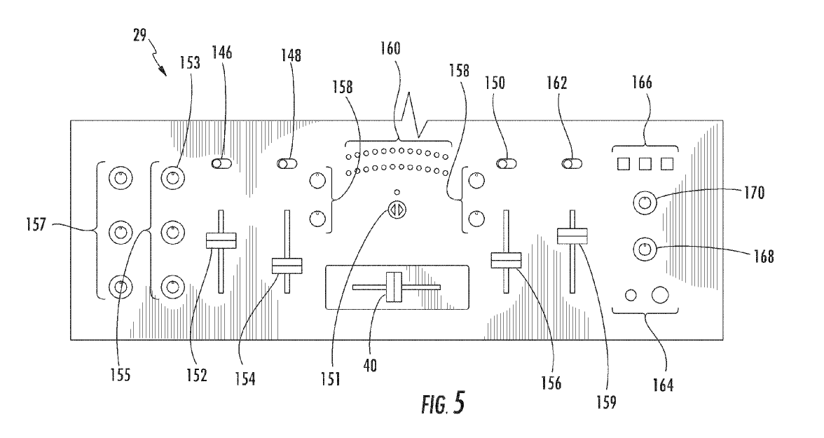

Referring now to FIG. 5, the mixing controls of the mixer 29 of the present invention are shown. The mixing controls generally include three selectable channels 146, 148, 150. Several input faders 152, 154, 156 are included to control the source levels that are assigned respectively to each channel 146, 148, 150. The first and second channels 146, 148 are selectable between the source of the first or second interfaces 26, 28 or the two sets channel inputs 30a, 30b respectively. The third channel 150 is selectable between the third line input 36 and the microphone input 44. The first and second channels 146, 148 also each include a stereo equalizer 158 to allow individual adjustment of the treble and bass levels of the respective source to compensate for differences in source audio quality.

The centerpiece of the mixer is the cross-fader control 40. The cross-fader control 40 selectively mixes the sources of the first and second channels 146, 148. An added feature of the cross-fader control 40 is that it is user-replaceable. Being able to remove and replace the control is essential to a DJ because they frequently wear out the cross-fader control 40 through prolonged use. Also included is a fader start control 150. Activation of the fader start control 151 allows media playback from one channel 146, 148 to start while the other is paused. A microphone input fader 153 is also included to allow individual adjustment of the microphone level. Microphone equalizers 155 are also included to allow individual adjustment of the microphone treble and bass levels. Also included is a master stereo equalizer 157 to adjust the final output equalization of treble, middle and bass levels. A master output fader controls 159 the overall output level. The overall output level is visually indicated by an LED meter 160. Also included is a stereo/mono toggle 162 to alternatively set the master output between stereo output and mono output.

A headphone jack 164 is included to allow the DJ to monitor the audio of the media player 10 by a pair of headphones (not shown). A monitor selector 166 allows the DJ to select which channel 146, 148, 150 will be communicated through the headphone jack 164 and to the pair of headphones worn by the DJ. The headphone level is adjusted by means of a headphone volume control 168. The DJ can also adjust the blend of master output and monitor sound being communicated to the headphones by means of a cue mix control 170. This feature is important for beat synchronizing, which was described above earlier.

5. Operation and Management of the Media Player

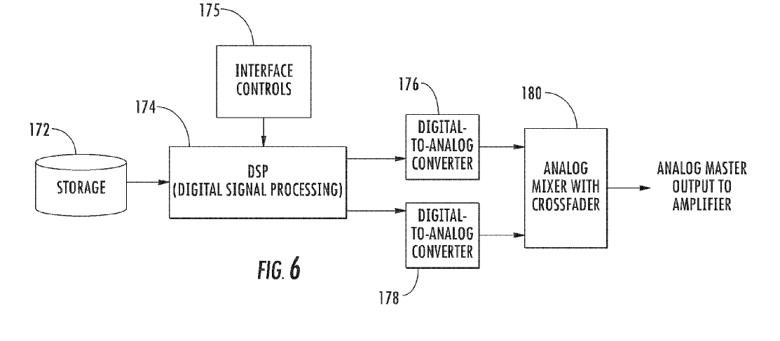

Referring now to FIG. 6, a flow chart of the preferred embodiment of the operation of the media player 10 of the present invention is shown. In this embodiment, the operation is a digital/analog hybrid. Media from the storage 172, such as the removable media devices 20, 22 or fixed storage device 24 described earlier, is processed by a digital signal processor 174 corresponding to the settings of the interface controls 175. The digital signal processor 174 provides two output signals that are communicated through digital-to-analog converters 176, 178. The analog output of the digital-to-analog converters 176, 178 is then mixed by an analog mixer 180 and communicated through the main outputs. Alternatively, a digital mixer could be substituted for the analog mixer 180. The digital-to-analog converters 176, 178 could then be removed and a digital-to-analog converter inserted at the output of the digital mixer. This would enable the media player 10 to fully play and mix the audio digitally, but output the audio in analog format suitable for listening.

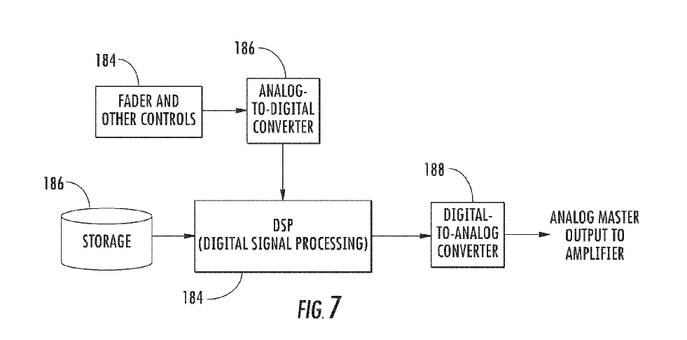

Referring now to FIG. 7, a flow chart of the operation of an alternative embodiment of the media player 10 of the present invention is shown. In this embodiment the mixing of the media is done digitally within a digital signal processor 182. Inputs from the analog mixer controls 184 are converted to digital signals by an analog-to-digital converter 186 and communicated into the digital signal processor 184. The digital signal processor 184 of the alternative embodiment mixes the media from the storage 186, such as the removable media devices 20, 22 or fixed storage device 24, and communicates the mixed output signal through a digital-to-analog converter 188, which communicates the resulting analog signal through the main outputs. Alternatively, a digital mixer controls could be substituted for the analog mixer controls 184. The digital-to-analog converter 186 could then be removed. This would enable the media player 10 to fully play and mix the audio digitally, but output the audio in analog format suitable for listening.

Management of the fixed storage drive, the DJ's inputs into the media player 10 and communications with an external computer are preferably accomplished by an operating system. Although the same functions may be performed by customized hardware. An operating system, however, provides the ability to be upgraded to support new features, which will be discussed more fully below.

In addition to the various controls discussed above, the DJ may enter inputs into the media player 10 through a series of menus. As discussed earlier, the DJ navigates and makes selections within the various menus using the jog wheel 62, back control 58, and select control 60. Activating the various menus is accomplished by activating the appropriate function control or the utility control 92.

A critical component to the operating system is a database of music characteristics such as track title, album title, artist, genre, and playing time. One such commercial song information database is the CDDB owned and maintained by Gracenote Corp., but other competing services exist. These databases will be collectively referred to as Compact Disc Data Base (“CDDB”) throughout this disclosure for the convenience of the reader. The CDDB can be queried for information and updated with new information. Parallel to the CDDB is the file system database, which includes corresponding information for the music stored on the fixed storage device 24. The file system database contains not only the characteristics of the music, but also references to the playlists with which a particular track is listed and custom edits to the characteristic data entered by the DJ.

Upon powering up the media player 10, a splash screen will be displayed in the matrix text area 94 of the displays 27. After displaying the splash screen, the operating system will query the second removable media devices 20, 22 to detect if media are loaded in either of the devices. If media is detected within either of the devices, the operating system will attempt to identify the type of media loaded in them, and will prompt the media type indicator 108 to display the appropriate value. The media type will also be displayed in an upper level menu. If no media are loaded in the drives or the media is unidentifiable, “No CD” will be displayed in the upper level menu instead. In addition to the media type, the upper level menu also has albums, genre, and play lists selections listed. If removable media is found within the second removable media devices 20, 22 on power-up of the media player 10, or removable media is loaded into the second removable media devices 20, 22 while the media player 10 is not currently playing music or in utility mode, the operating system will indicate the names of the tracks on the appropriate display 27. To accomplish this feature, the operating system invokes a CDDB look-up function, which queries the CDDB for the corresponding information. If the query can not find the corresponding information, the tracks will be displayed in sequentially increasing track numbers. If the CDDB returns erroneous information or is otherwise unavailable, the DJ can toggle between the track number identification and the information found by activating the info control 78. The DJ can then use the jog wheel 62 and play/pause control 66 to start playing the song immediately, or the cue control 67 to put the playback point at the beginning of the track and in pause.

To descend into the upper level menu categories the DJ uses the jog wheel 62 to highlight the desired category and the select control 60 to open the category. For instance, if the artist category is selected, the display 27 will show a menu of the artists that have songs stored on the fixed storage device 24. Selecting a particular artist will open into a new menu, which lists the songs by that artist that are currently stored on the fixed storage device 24. The DJ can then select a song to play, cue, add to a play list, or to delete. Descending into the genre category will prompt the operating system to activate a menu of different music genres available such as jazz, pop, alternative, and new age. Selecting a specific genre will prompt the operating system to activate a menu listing all of the current songs stored on the fixed storage device 24 that are categorized within that genre as identified by the CDDB and/or file system database.

The DJ can also search for music rather than browse through the menus. As described earlier, the search control 76 activates a search menu. The search menu presents the DJ with four options: search by artist, by album, by song, and by play list. The DJ makes his selection using the jog wheel 62 and activates either the select control 60 or search control 76 to confirm the selection. After the selection has been confirmed, the DJ will be presented with a search input screen.

The search input screen is where the DJ can enter an alphanumeric character string that the operating system will use to search the fixed storage device 24. The DJ has two methods he or she can use to enter the search string. First, the DJ can use a conventional keyboard connected to the keyboard connector 52 on the rear panel 18 of the media player 10. Second, the DJ can use the jog wheel 62 and select control 60 to enter in a search string. Rotating the jog wheel 62 clockwise will scroll through the characters “A” through “z” and the digits “0” through “9.” Rotating the jog wheel 62 counter clockwise will scroll through the same characters and digits, but in reverse order. If the DJ selects an incorrect character, the DJ can erase the entered character by activating the save/del control 88.

After the search string is entered, activating the search control 76 will prompt the operating system to start the search. A search result screen will be displayed by the operating system with a list of all songs that matched or partially matched the search string. A particular song may be selected for by using the jog wheel 62 and select control 60. Activating the back control 58 or the search control 76 will prompt the operating system to return to the upper level menu.

If the DJ desires to view more information about a particular song, such as the artist, album, play length, or compression rate, the DJ can activate the info control 78 while the song is selected. All the characteristics about the song as retrieved from the file system database, or CDDB as appropriate, will be displayed in a full song information screen. By activating and holding the info control 78 for two (2) seconds, the operating system is prompted to display the song information editing screen.

The song information editing screen allows the DJ to change the information characteristics of the song. The saved changes will be saved to the file system database. The DJ may want to do this because the song's information does not appear in the CDDB or the information retrieved form the CDDB is erroneous. The DJ uses the jog wheel 62 and select control 60 to select the characteristic that he or she desires to edit. Once the characteristic is selected, a cursor will appear that covers the width of one character.

The cursor initially appears over the first character. Activating the select control 60 advances the cursor one character. Activating the back control 58 retreats the cursor one character. The DJ uses either a keyboard or the jog wheel 62, as described in entering a search string, to enter any changes to the characteristic. If the DJ has no desire to change the information in a particular characteristic or wishes to abandon any changes made, activating the back control 58 while the cursor is on the first character of the particular characteristic will allow the DJ to select another characteristic to edit using the jog wheel 62.

To save any changes made to the characteristic, the DJ activates the save/del control 88. Activating the info control 78 prompts the operating system to leave the song information editing screen and return to the upper level menu.

To create and sequence a play list, the DJ first searches or browses for the tracks he or she desires to add to a play list. Once the DJ finds a desired track, the DJ activates the program control 84 to add the track to the play list. Activating the program control 84 prompts the operating system to add the track to the play list, and to mark the selected track as having been added to the play list. Activating the program control 84 over a marked track will deselect the track from the play list and un-mark the track.

Once all the tracks that the DJ desires have been added to the play list, the DJ may save the play list by activating the save/del control 88. The operating system is prompted to display a current play list screen, which has a list of the selected tracks. Activating the save/del control 88 a second time prompts the operating system to save the play list. In order to complete the saving process, the operating system prompts the DJ to enter a name for the play list. The DJ may enter a name either using a keyboard or by using the jog wheel 62 and select control 60. If the DJ desires to change the name of the play list at a later time, the DJ may do so by selecting the play list using the jog wheel 62 and then activating and holding the info control 78 for two (2) seconds. The DJ may then edit the play list name like editing the characteristics of tracks described above.

If the DJ is unhappy with the order of the selected tracks or desires to add or delete some of the selected tracks, the DJ may activate the back control 58 and proceed to select additional tracks and deselect previously selected tracks. By selecting and deselecting tracks, the DJ may reorder the play list too.

If the DJ does not desire to save the current play list, but still wants to play the tracks in the current play list, the DJ can play the current play list by activating the play/pause control 66.

If the DJ does not want to play all of the tracks in the play list, the DJ can deselect the undesired tracks by selecting them with the jog wheel 62 and then activating the program control 84. The operating system is also prompted to un-mark the selected track.

Another feature of the operating system of the media player 10 is the ability to record tracks from the removable media devices 20, 22 or a signal from the channel inputs 30a, 30b or third line input 36 and then to compress the track or signal into a compact storage format such as—but not restricted to—MP3, MPEG-2, OGG, WMA, AAC, MLP, M4A. To record from the second removable media devices 20, 22, the DJ must load removable media into one of the second removable media devices 20, 22, select either the title or a track using the jog wheel 62, and then activate the appropriate record control 86. Selecting the title field of the media will prompt the operating system to record the entire contents of the media. Selecting a particular track of the media will prompt the operating system to record only that track. Activating the record control 86 prompts the operating system to enter record mode and to display a record options screen. The record options screen presents the DJ with a number of options. These options include: rapid archive, save and compress, and external line in. The rapid archive record option copies the track or album onto the fixed storage device 24 in a raw format. This feature is useful to the DJ during a performance as it allows the DJ to rapidly transfer tracks from media to the fixed storage device 24. The save and compress record option compresses the raw content of the media into a compressed format such as—but not restricted to—MP3, MPEG-2, OGG, WMA, AAC, MLP, M4A, according to the user defined settings set in the utility menu, described more fully below. The DJ uses the jog wheel 62 and select control 60 to make the desired choice. During recording, the operating system will update the matrix text area 94 of the appropriate display 27 with its progress.

To record from the channel inputs 30a, 30b or third line input 36, the DJ selects the external line in option from the record options screen using the jog wheel 62 and then activating the play/pause control 66. The operating system will then start recording from the selected input 30a, 30b, 36 and prompt the matrix text area 94 of the appropriate display 27 to display an external line in screen. If the DJ desires to create tracks during recording of the selected input 30a, 30b, 36, activating the record control 86 will prompt the operating system to mark the end of the current track and save it. The operating system will then continue to record from the selected input 30a, 30b, 36 and assign a new sequential track number to the recording. The DJ can then later edit the names of the tracks using the info control 78 as described earlier. To stop recording, the DJ activates the play/pause control 66 again. Activating the save/del control 88 causes the operating system to prompt the DJ to enter the values for the characteristics of the recording such as the name of the genre, album, artist and track. The DJ uses the jog wheel 62 and select control 60 to select the desired field to edit. The DJ then uses in combination the back control 58, select control 60 and jog wheel 62 to make the desired name change. The DJ confirms the name change by activating the save/del control 88. After entering the desired name changes for the relevant fields, activating the save/del control 88 again saves the recording to the digital storage drive in the file system database.

As previously described, activating the utility control 92 invokes the operating system to display a utility menu screen. The Utility menu screen presents the DJ with a number of sub-menus including compression, delete, system, password and custom menus. The DJ enters a desired sub-menu by using the jog wheel 62 and select control 60 to select the desired sub-menu.

Selecting the compression sub-menu presents the DJ with the compression options screen. The compression options screen has three (3) settings the DJ can adjust. These settings are the sampling rate for the second removable media devices 20, 22, the sampling rate for the channel inputs 30a, 30b or third line input 36, and the option to compress tracks previously rapid archived. The sampling rate for the second removable media devices 20, 22 can be adjusted between several settings. These settings include: 128 kbps, 320 kbps, and CD (PCM) audio. The higher the sampling rate the higher the sound quality will be of the resulting track, but it comes at the price of having a larger file. The option to compress previously recorded tracks that had been rapid archived, compresses the tracks into a compact storage format, and deletes the rapid archive file. This option is useful to the DJ as a house cleaning function after performances where the DJ transferred tracks from the second removable media devices 20, 22 to the fixed storage device 24 through the rapid archive feature.

Selecting the delete sub-menu presents the DJ with a deletion options screen. The deletion options screen first prompts the DJ for a password. The DJ enters the password using either the keyboard or the jog wheel 62 and select control 60. Setting a password is discussed in detail below. After entering a correct password, the operating system will present the DJ with a number of options. The options include searching: by album, by artist, by play list, and reformat. These options enable the DJ to search for particular tracks as they are categorized or to delete an entire category. For example, the DJ could delete all the tracks attached to a particular album or a particular track on the album. The play list option enables the DJ to delete the play list or to search for and delete particular tracks that are listed in the play list. The reformat option enables the DJ to delete the entire fixed storage device 24. When the DJ has selected the desired target to delete, activating the save/del control 88 prompts the operating system to confirm whether the DJ desires to proceed with deleting the target. The DJ activates the save/del control 88 again to confirm and execute the deletion.

Selecting the system sub-menu presents the DJ with a system options screen. The system options screen presents the DJ with a number of options. These options include: capacity, version number, firmware update, and defragment. Selecting the capacity option invokes a total capacity screen, which displays the characteristics of the fixed storage device 24 such as total size of the storage, remaining storage on the device, the amount of space that could be saved through compression of uncompressed files, and remaining storage estimated in units (hours, minutes, seconds) of playing time. Selecting the version number option presents the DJ with the version information of the operating system. Selecting the firmware update option enables the DJ to update the operating system through a personal computer connected to the data port 50. Selecting the defragment option prompts the operating system to reallocate how the data is stored on the fixed storage device 24 for optimal access.

Selecting the password sub-menu presents the DJ with a password setting screen. The password setting screen enables the DJ to set a password to protect access to the media player 10. The operating system prompts the DJ to enter the old password. The DJ uses the keyboard or the jog wheel 62, back control 58, and select control 60 to enter the old password. The DJ confirms the old password by activating the save/del control 88. After the DJ confirms the old password, the operating system prompts the DJ for the new password. The DJ uses the same procedure to enter in and confirm the new password. After the DJ confirms the new password, the new password is set.

Selecting the custom sub-menu presents the DJ with a custom options screen. The custom options screen presents the DJ with a number of options. These options include: enabling and disabling CDDB lookup, and setting a time period for auto-closing the doors on the second removable media devices 20, 22. Selecting the CDDB lookup option enables the DJ to enable and disable the auto-lookup feature of the operating system. Selecting the auto-door closing option enables the DJ to set a time period to automatically close the access door to the corresponding removable media device if it has been left open. This feature may also be disabled to prevent the access doors of the second removable media devices 20, 22 from automatically closing.

If the DJ connects the media player 10 to a personal computer (not shown) via the data port 50, the operating system will display a connected screen informing the DJ of the connection. The DJ can then use software on the personal computer to upload and download media files and to manage all of the functions described above. Disconnecting the personal computer form the data port 50 prompts the operating system to reset the media player 10.

In addition to managing the functions of the media player 10, the software utility on the personal computer is capable of updating the firmware, i.e. operating system, of the media player 10. This valuable feature means not only can the DJ have the latest available software, but it also allows the manufacturer to release a product earlier to market, and reduces service costs and down time for both the customer and manufacturer. The software utility can also transfer songs between the media player 10 and personal computer; delete songs; allow editing song ID tag data stored in the file system of the media player 10; create, edit and delete playlists and playlist data; allow updating of the CDDB information. Furthermore the software utility may export a complete list of all songs stored in the media player 10. The resulting list may be inserted into any other database or spreadsheet program such as Microsoft Access or Excel programs. These features are very useful for the DJ who wants to share a list of his/her music with a client. The software utility also allows the formatting of a new fixed storage device 24 to work with the media player 10. This is important to allow users to upgrade their media player 10 with a newer or replacement fixed storage device 24.

Therefore, it can be seen that the present invention provides a unique solution to the problems of the prior art by providing a complete all-in-one digital DJ setup that obviates the need for separate mixers and separate audio sources.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

1. A media player and mixer, comprising:
means for storing media;
an output;
an interface, having a selectable setting, a first signal and a second signal, the interface connected to the means for storing media, the interface generating the first signal and the second signal by selectively playing the media of the means for storing media;
means for mixing the first signal and second signal into a mixed signal, the mixed signal being communicated through the output.

2. The device of claim 1, wherein the means for storing media is a hard disc drive.

3. The device of claim 1, wherein the means for storing media is a compact disc drive.

4. The device of claim 1, wherein the means for storing media, comprises:
a fixed storage drive connected to the interface;
a first removable storage drive connected to the fixed storage drive and the interface; and
a second removable storage drive connected to the fixed storage drive and the interface.

5. The device of claim 1, wherein the means for mixing the first signal and second signal further comprises a crossfader control.

6. A media player and mixer, comprising:
means for storing media;
an output;
a first interface, having a selectable setting and a first signal, the first interface connected to the means for storing media, the first interface generating the first signal by selectively playing the media of the means for storing media;
a second interface, having a selectable setting and a second signal, the second interface connected to the means for storing media, the second interface generating the second signal by selectively playing the media of the means for storing media; and
means for mixing the first signal and second signal into a mixed signal, the mixed signal being communicated through the output.

7. The device of claim 5, wherein the means for storing media is a hard disc drive.

8. The device of claim 5, wherein the means for storing media is a compact disc drive.

9. The device of claim 5, wherein the means for storing media, comprises:
a fixed storage drive connected to the interface;
a first removable storage drive connected to the fixed storage drive and the interface; and
a second removable storage drive connected to the fixed storage drive and the interface.

10. The device of claim 5, wherein the means for mixing the first signal and second signal further comprises a crossfader control.

11. A media player and mixer, comprising:
a fixed storage device capable of storing and playing media thereon;
a first removable storage device capable of retrieving media from removable media placed therein;
a second removable storage device capable of retrieving media from removable media placed therein;
an output;
a first interface, having a selectable setting and a first signal, connected to the fixed storage device and the first removable storage device, the first interface generating the first signal by selectively playing the media of the fixed storage device and the first storage device;
a second interface, having a selectable setting and a second signal, connected to the fixed storage device and the second removable storage device, the second interface generating the second signal by selectively playing the media of the fixed storage device and the second removable storage device; and
a mixer having a selectable setting and connected to the output, the first signal and the second signal, the mixer selectively mixing the first signal and the second signal into a mixed signal, the mixed signal being communicated through the output.

12. The device of claim 11, wherein the fixed storage device is a hard disc drive.

13. The device of claim 11, wherein the first removable storage device is a compact disc drive.

14. The device of claim 11, wherein the second removable storage device is a DVD optical drive.

15. The device of claim 11, wherein the means for mixing the first signal and second signal further comprises a crossfader control.
